(19) United States
(12) Patent Application Publication
(10) Pub. No.: US 2013/0155292 A1
(43) Pub. Date: Jun. 20, 2013

(54) IMAGING APPARATUS AND METHOD

(71) Applicant: Samsung Electronics Co., Ltd., Gyeonggi-do (KR)

(72) Inventor: Mineki TAOKA, Kanagawa (JP)

(73) Assignee: Samsung Electronics Co., Ltd., Gyeonggi-do (KR)

(21) Appl. No.: 13/705,823

(22) Filed: Dec. 5, 2012

(30) Foreign Application Priority Data
Dec. 14, 2011 (JP) 2011-273556

(51) Int. Cl. H04N 5/232

(52) U.S. Cl. CPC H04N 5/23296
USPC 348/240.2

(57) ABSTRACT

An imaging apparatus and method are provided. Pixel values of each line of a resized image are sequentially obtained by resizing an input image using pixel values of the input image that are sequentially obtained from an imaging element, wherein the resized image has a first number of lines. Pixel values of each line of a distortion-corrected image are sequentially obtained by performing distortion correction on the resized image using pixel values of one or more lines of the resized image, wherein the distortion-corrected image has a second number of lines. The first number of lines is set to have any two of positions in the resized image that are closest to each other in a vertical direction and that correspond to pixels of the distortion-corrected image, which have a distance that is greater than or equal to a line distance of the resized image.

### PRIORITY

This application claims priority under 35 U.S.C. §119(a) to a Japanese Patent Application filed in the Japanese Patent Office on Dec. 14, 2011, and assigned Serial No. 273556/2011, the entire disclosure of which is incorporated herein by reference.

### BACKGROUND OF THE INVENTION

1. Field of the Invention

The present invention relates generally to an imaging apparatus and method, and more particularly, to an imaging apparatus and method that reduces power consumption.

2. Description of the Related Art

Imaging devices may be considered digital cameras or camcorders that capture digital images with imaging elements. The imaging device controls the imaging element to perform photoelectric conversion of an incident light beam via a lens. A digital image is generated from the converted electric signal, and the digital image is stored in a recording media or an embedded memory.

In the imaging apparatus, since the incident light beam via the lens reaches the imaging element, the generated digital image may contain distortion caused by the lens. Thus, imaging devices are equipped with technologies that compensate for the distortion of the digital image.

For example, one such technology compensates for distortion using pixel values of a digital image for each block, after reading out the pixel values stored in a frame memory block by block.

However, in conventional technologies, since digital images are once accumulated in a temporary storage memory and accessed at a time for distortion compensation, frequency of access to the memory increases, which also leads to an increase of power consumption.

### SUMMARY OF THE INVENTION

The present invention has been made to address at least the above problems and/or disadvantages and to provide at least the advantages described below. Accordingly, an aspect of the present invention provides an imaging apparatus and method that reduces power consumption by reducing frequency of access to a memory for temporarily storing an image.

In accordance to an aspect of the present invention, an imaging apparatus is provided that includes a resizer for sequentially obtaining pixel values of each line of a resized image by resizing an input image using pixel values of the input image that are sequentially obtained from an imaging element, wherein the resized image has a first number of lines. The imaging apparatus also includes a distortion corrector for sequentially obtaining pixel values of each line of a distortion-corrected image by performing distortion correction on the resized image using pixel values of one or more lines of the resized image, wherein the distortion-corrected image has a second number of lines. The first number of lines is set to have any two of positions in the resized image that are closest to each other in a vertical direction and that correspond to pixels of the distortion-corrected image, which have a distance that is greater than or equal to a line distance of the resized image.

In accordance to another aspect of the present invention, an imaging method is provided. Pixel values of each line of a resized image are sequentially obtained by resizing an input image using pixel values of the input image that are sequentially obtained from an imaging element, wherein the resized image has a first number of lines. Pixel values of each line of a distortion-corrected image are sequentially obtained by performing distortion correction on the resized image using pixel values of one or more lines of the resized image, wherein the distortion-corrected image has a second number of lines. The first number of lines is set to have any two of positions in the resized image that are closest to each other in a vertical direction and that correspond to pixels of the distortion-corrected image, which have a distance that is greater than or equal to a line distance of the resized image.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a set of diagrams illustrating image distortion;

FIG. 2 is a diagram illustrating a distortion correction process, according to an embodiment of the present invention;

FIG. 3 is a set of diagrams illustrating a distance between positions in an input image that correspond to pixels of a distortion-corrected image, according to an embodiment of the present invention;

FIG. 4 is a block diagram illustrating an imaging apparatus, according to an embodiment of the present invention;

FIG. 5 is a set of diagrams illustrating two positions closest to each other in the vertical direction, according to an embodiment of the present invention;

FIG. 6 is a flowchart illustrating a schematic imaging method, according to an embodiment of the present invention; and

FIG. 7 is a block diagram illustrating a conventional imaging apparatus, according to an embodiment of the present invention.

### DETAILED DESCRIPTION OF EMBODIMENTS OF THE PRESENT INVENTION

Embodiments of the present invention are described in detail with reference to accompanying drawings. The same or similar components may be designated by the same or similar reference numerals although they are illustrated in different drawings. Detailed descriptions of constructions or processes known in the art may be omitted to avoid obscuring the subject matter of the present invention.

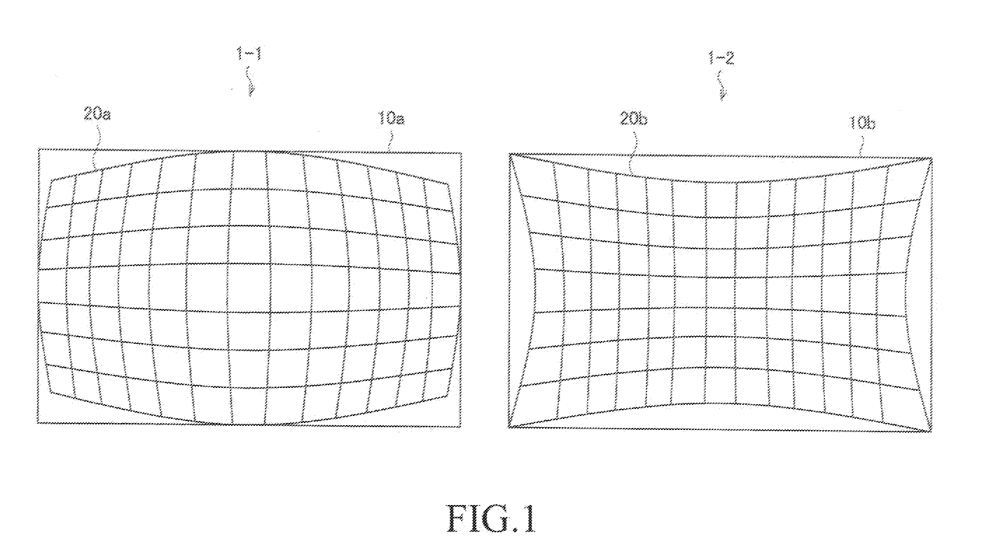

FIG. 1 is a set of diagrams illustrating image distortion. Referring to FIG. 1, an input image 10a involving distortion, and a range 20a and 20b in the input image 10a and 10b that corresponds to a distortionless image, in case of projecting the distortionless image to the input image 10a and 10b, are illustrated in diagrams 1-1 or 1-2. Image distortion shown in diagram 1-1 is called barrel distortion, while image distortion in the diagram 1-2 is called pincushion distortion. Such image distortion depends on lens characteristics and the focal length.

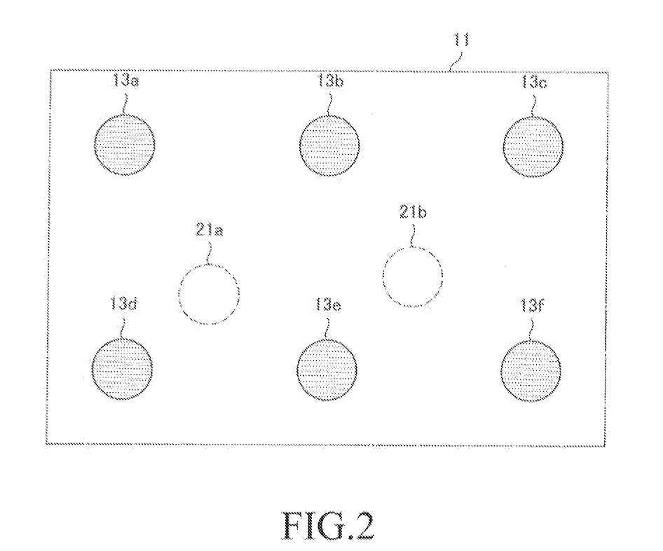

The imaging apparatus that performs distortion correction has information about distortion caused by the lens, such as the range 20a and 20b in the input image 10a and 10b corresponding to the distortionless image. Specifically, the imaging apparatus has, for example, information about a position in the input image that corresponds to each pixel in the distortionless image (hereinafter, referred to as a ‘corresponding position’), i.e., information about a projected position when each pixel of the distortionless image is projected onto the input image 10a and 10b. The imaging apparatus obtains pixel values of the distortionless image (i.e., distortion-corrected image) by performing an interpolation process using pixel values of pixels of the input image 10a and 10b that surround the corresponding position, as described in greater detail below, with reference to FIG. 2.

FIG. 2 is a diagram illustrating the distortion correction process, according to an embodiment of the present invention. Referring to FIG. 2, in a partial area 11 of the input image 10, pixels 13a-f of the input image 10 and corresponding positions 21a-b in the input image 10 that correspond to pixels of the distortion-corrected image are shown. For example, by performing interpolation using the four pixels 13a, 13b, 13d, and 13e that surround corresponding position 21a, a pixel value of a pixel of the distortion-corrected image corresponding to the corresponding position 21a is obtained. Similarly, for example, by performing interpolation using four pixels 13b, 13c, 13e, and 13f that surround corresponding position 21b, a pixel value of a pixel of the distortion-corrected image corresponding to the corresponding position 21b is obtained. In this manner, by obtaining each pixel value of the distortion-corrected image, the entire distortion-corrected image may be finally obtained.

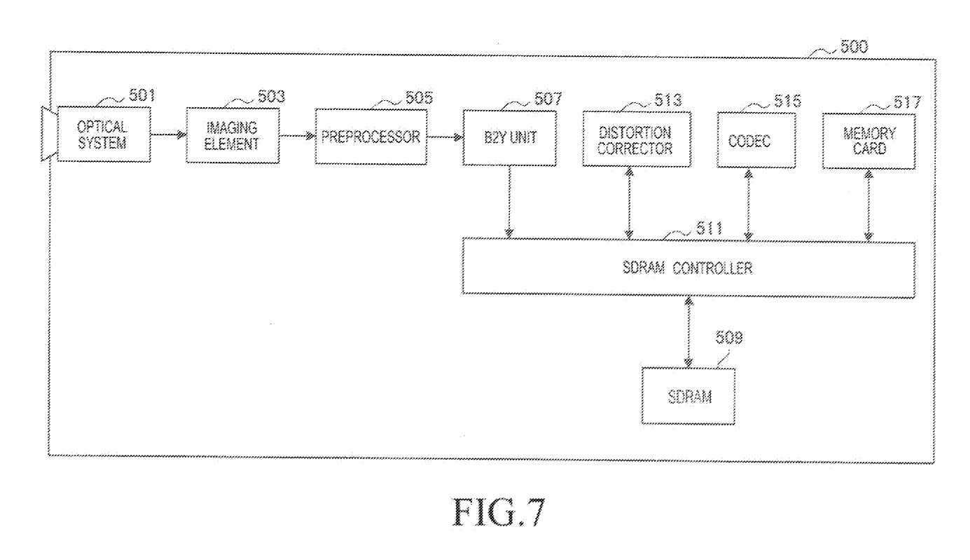

FIG. 7 is a diagram illustrating a conventional imaging apparatus 500, according to an embodiment of the present invention. The imaging apparatus 500 may be embodied as a digital camcorder. Referring to FIG. 7, in the imaging apparatus 500, a light beam is received through an optical system 501, and is subject to photoelectric conversion and Analog to Digital (A/D) conversion in an imaging element 503. As a result, RAW data in the Bayer pattern is obtained. The RAW data includes data, in an embodiment of the present invention, having pixels of 4,000 columns×2,000 lines. A preprocessor 505 performs shading correction, defect compensation, noise elimination, etc. on the RAW data.

A B2Y unit 507 converts the RAW data to an image represented with luminance Y and chrominance Cb, Cr (hereinafter, referred to as a ‘YCbCr image’). The image is stored in an SDRAM 509 under control of an SDRAM controller 511. In an embodiment of the present invention, the image corresponds to each frame of a full high vision image having pixels of 1,920 columns×1,080 lines.

A distortion corrector (also known as a distortion compensator) 513 accesses the SDRAM 509 to obtain the image and performs distortion correction on the image. The distortion-corrected image is also stored in the SDRAM 509.

The distortion-corrected image undergoes compression encoding, such as, for example, Moving Picture Experts Group (MPEG) (e.g., MPEG2, MPEG4, H.246, etc.), encoding in a codec 515, and is stored in a memory card 517.

A conventional imaging apparatus performs the distortion correction process by reading out an image after the image is stored in a temporary storage memory, such as SDRAM. This increases the frequency of access to the memory, which in turn increases power consumption. It also expands a capacity of the memory since both an image before distortion correction and a distortion-corrected image are stored in the temporary storage memory.

Thus, an embodiment of the present invention makes it possible to reduce power consumption by lessening the frequency of access to a memory, such as an SDRAM, for temporarily storing an image. It also enables a reduction in the capacity of the memory.

Specifically, in an embodiment of the present invention, a method of processing distortion correction without preserving an image in the temporary storage memory is introduced. In other words, as a pipelining process, pixel values of the input image (e.g., the YCbCr image) are sequentially obtained by the imaging apparatus, and sequentially undergo the distortion-correction process. The distortion-corrected image is stored in the memory. The distortion correction process is performed as an On-The-Fly operation for the temporary storage memory, which reduces frequency of access to the memory during the distortion correction process.

However, there may be an instance where not all pixel values of a distortion-corrected image are output when the distortion correction process is sequentially performed using pixel values of an image sequentially obtained by the imaging element. Specifically, for example, pixel values of each line of the input image (e.g., YCbCr image) are sequentially obtained from signals continuously output from the imaging element. Once pixel values of one or more lines of the input image required to generate pixel values for one line of the distortion-corrected image are obtained, pixel values of the one line of the distortion-corrected image may be calculated. In other words, in the pipelining process, pixel values of each line of the input image 10 are sequentially obtained, and thus, pixel values of the distortion-corrected image are sequentially calculated line by line. Since signals are continuously output from the imaging element, pixel values of the distortion-corrected image are required to calculate and output without an input delay of pixel values of the input image, in the distortion correction process. However, in the distortion correction process, a relationship between the number of lines of input pixel values and the number of lines of output pixel values depends on an area in the image, and thus, sometimes, the number of lines of output pixel values happens to be greater than the number of lines of input pixel values. Because of this, a handshake for pixel values of a line of the input image is required. As a result, outputs become delayed with respect to continuous inputs and the distortion correction process in the pipelining does not work.

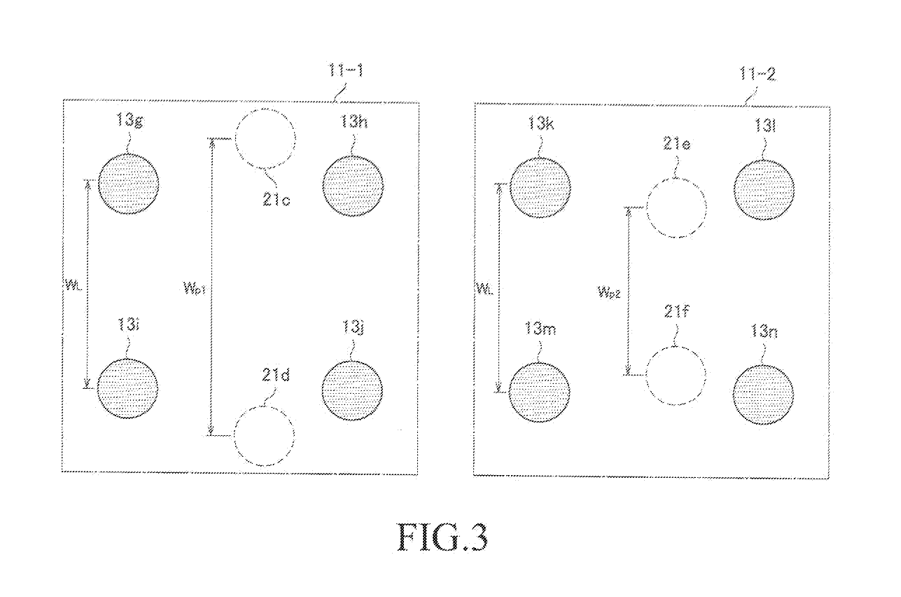

FIG. 3 is a set of diagrams illustrating a distance between positions in the input image that correspond to pixels of a distortion-corrected image, according to an embodiment of the present invention. Referring to FIG. 3, in a partial area of the input image, pixels 13g-13n of the input image 10 and corresponding positions 21c-21f in the input image 10, which correspond to pixels of the distortion-corrected image, are shown. As described in connection with FIG. 2, in an embodiment of the distortion correction process, by performing interpolation using sets of four pixels surrounding corresponding position, pixel values of pixels of the distortion-corrected image corresponding to the corresponding positions are obtained.

For example, two corresponding positions 21c and 21d, closer to each other in the vertical direction, are included in an area 11-1. A distance between corresponding positions 21c and 21d is Wp1, which is greater than a distance WL between pixels 13g and 13i. Thus, in this area 11-1, there is no case where outputs are delayed with respect to inputs. In other words, once, on the input image side, pixel values of a line including pixels 13g and 13h are obtained, a pixel value of a pixel corresponding to the corresponding position 21c may be calculated on the distortion-corrected image side. For the distortion-corrected image, if it is possible to equally calculate a pixel value for another pixel included in the same line as the corresponding position 21c, pixel values of the pixel for the corresponding position 21c and the other pixel included in the same line as the pixel for the corresponding position 21c may be calculated. On the input image side, pixel values of a next line including pixels 13i and 13j are obtained, but no pixel values are calculated on the distortion-corrected image side. If, on the input image side, another next line is obtained, a pixel value of a pixel corresponding to the corresponding position 21d may be calculated on the distortion-corrected image side. For the distortion-corrected image, if it is possible to equally calculate a pixel value for another pixel included in the same line as the corresponding position 21d, pixel values of the pixel for the corresponding position 21d and the other pixel included in the same line as the pixel for the corresponding position 21d may be calculated. As such, in the area 11-1, in which less outputs are obtained from more inputs, i.e., in the reduced area 11-1, the handshake for pixel values of a line of the input image 10 is not required, and thus, outputs are not delayed with respect to inputs.

On the other hand, for example, two corresponding positions 21e and 21f, adjacent to each other in the vertical direction, are included in an area 11-2. A distance between corresponding positions 21e and 21f is Wp2, which is smaller than WL between pixels 13k and 13m. Thus, in the area 11-2, there may be a case where outputs are delayed with respect to inputs. In other words, once, on the input image side, pixel values of a line including pixels 13m and 13n are obtained, calculation of pixel values of pixels corresponding to corresponding positions 21e and 21f may be possible on the distortion-corrected image side. For the distortion-corrected image, calculation of pixel values of other pixels included in the same lines as the corresponding positions 21e and 21f, respectively, is also possible in the same way, calculation of pixel values of the two lines is required. As such, in the area 11-2 where more outputs (e.g., pixel values of two lines) are obtained from less inputs (e.g., pixel values of one line), i.e., in the expanded area 11-2, the handshake for pixel values of a line of the input image 10 may be required. As a result, outputs become delayed with respect to inputs, and the distortion correction process in the pipelining process does not work.

By taking the above description into account, the present invention ensures that the distortion correction process works by introducing a technique of performing distortion correction without preserving an image in the temporary storage memory. It lessens the frequency of access to the temporary storage memory, such as the SDRAM 509, and in turn reduces power consumption.

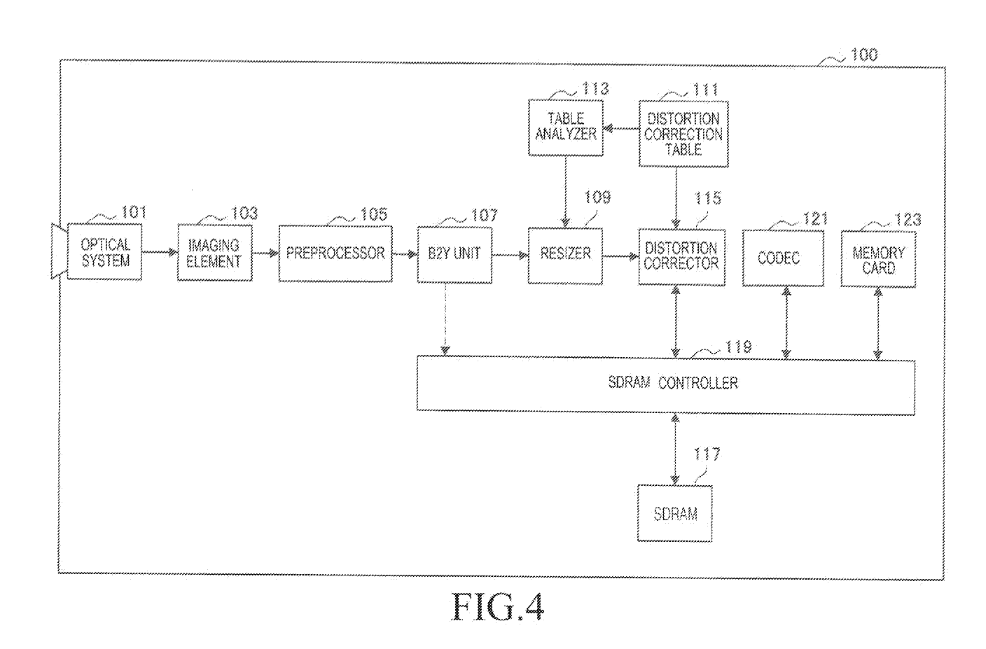

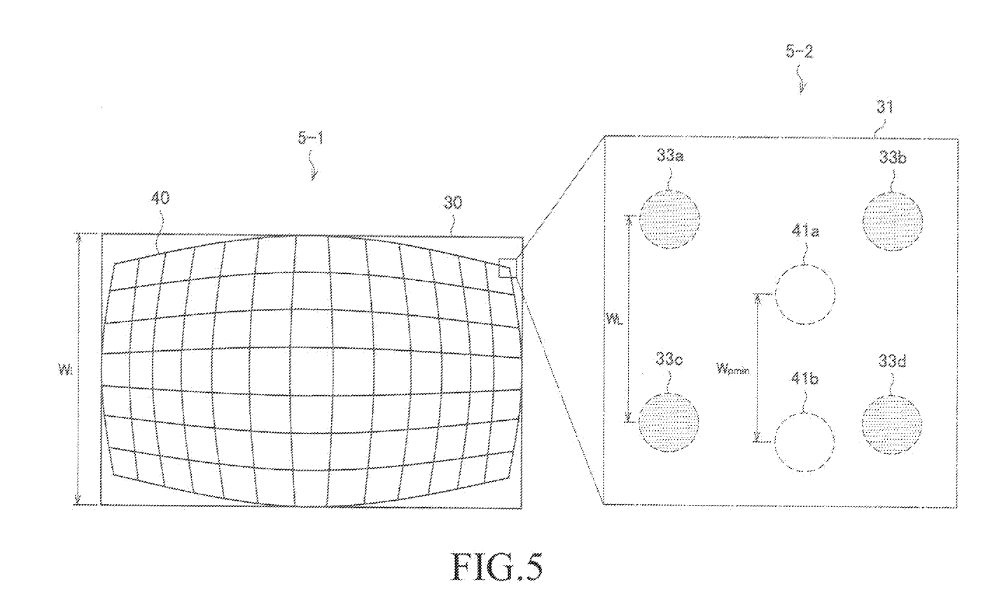

A configuration of an imaging apparatus 100 is described below with reference to FIGS. 4 and 5. FIG. 4 is a block diagram illustrating the imaging apparatus 100, according to an embodiment of the present invention. Referring to FIG. 4, the imaging apparatus 100 includes an optical system 101, an imaging element 103, a preprocessor 105, a B2Y unit 107, a resizer 109, a distortion correction table 111, a table analyzer 113, a distortion corrector 115, an SDRAM 117, a SDRAM controller 119, a codec 121, and a memory card 123. The table analyzer 113 is an example of a calculator and storage unit. In an embodiment of the present invention, the imaging apparatus 100 is embodied as a digital camcorder, for example.

The optical system 101 guides a light beam to the imaging element 103 located in the imaging apparatus 100. In other words, the optical system 101 forms an image on an imaging surface of the imaging element 103. The optical system 101 may adjust the focal length for imaging. The optical system 101 includes, for example, a focus lens and a zoom lens.

The imaging element 103 performs photoelectric conversion. That is, the imaging element 103 converts the light beam guided from the optical system 101 into an electric signal.

The imaging element 103 uses an A/D converter to perform A/D conversion on the electric signal. As a result, RAW data in the Bayer pattern is obtained. The RAW data includes data having pixels of 4,000 columns×2,000 lines, according to an embodiment of the present invention. The imaging device 103 may be embodied as a Charge Coupled Device (CCD) image sensor, or a Complementary Metal Oxide Semiconductor (CMOS) image sensor.

The preprocessor 105 performs a pre-processing task on the RAW data. For example, the preprocessor 105 may performs shading correction, defect compensation, and/or noise elimination on the RAW data.

The B2Y unit 107 sequentially obtains pixel values of the input image 10 via the imaging element 103. Specifically, the B2Y unit 107 converts the RAW data output from the imaging element 103 and processed by the preprocessor 105 into the YCbCr image, represented with luminance Y and chrominance Cb, Cr. The imaging element 103 continuously outputs individual pieces of the RAW data, and the preprocessor 105 sequentially processes individual pieces of the RAW data and outputs the processed individual pieces of the RAW data. In order To perform the described operations, the B2Y unit 107 sequentially obtains pixel values of the YCbCr image by obtaining individual pieces of the RAW data, and sequentially performs conversion on the individual pieces of the RAW data. The B2Y unit 107 sequentially outputs the pixel values of the YCbCr image to the resizer 109.

The YCbCr image is an image that involves distortion caused by the optical system 101, which is the input image subject to distortion compensation. The YCbCr image includes, for example, pixels of 4,000 columns×2,000 lines.

The B2Y unit 107 may also write the YCbCr image into the SDRAM 117. However, in an embodiment of the present invention, the YCbCr image from the B2Y unit 107 is not written into the SDRAM 117.

The resizer 109 sequentially obtains pixel values of each line of a resized image having L1 lines by resizing the YCbCr image using sequentially obtained pixel values of the YCbCr image. For example, the resizer 109 sequentially obtains pixel values of each line of the resized image (resized YCbCr image) having L1 lines by performing an interpolation process using pixel values of the YCbCr image sequentially output by the B2Y unit 107. The resizer 109 also outputs pixel values of each line to the distortion corrector 115.

L1, the number of lines, is set up to have any two of positions in a resized image that correspond to pixels of the distortion-corrected image (hereinafter, referred to as ‘corresponding positions’), which are closest to each other in the vertical direction in the resized image, and distanced no less than a line distance of the resized image. The distortion-corrected image is obtained from the distortion correction process for the resized image, which is performed by the distortion corrector 115, as described in greater detail below. As already described in connection with FIG. 3, if there are two corresponding positions closest to each other in the vertical direction, a balance of inputs and outputs in the distortion correction process varies depending on a distance between the two corresponding positions. Specifically, if the distance between the two corresponding positions adjacent to each other is less than the line distance of the resized image, more outputs (e.g., pixel values for two lines) are generated for less inputs (e.g., pixel values for one line). Because of this, a handshake for pixel values of a line of the resized image is required. As a result, there may be a case where, for continuously obtained pixel values of a line of the resized image, calculation of pixel values of the distortion-corrected image is delayed, and thus, the distortion correction in the pipelining process may not work. On the other hand, if two adjacent corresponding positions are distanced no less than the line distance of the resized image, outputs no more than inputs are only generated for the inputs in the distortion correction process. Accordingly, a handshake for pixel values of a line of the resized image is not required, and thus, the distortion correction process works. Thus, if any two corresponding positions are distanced no less than the line distance of the resized image, i.e., if the entire resized image is a reduced image in the distortion correction process, it is possible to ensure performance of both the distortion correction process and pipelining process. Furthermore, the line distance of the resized image lessens as the number of lines, L1, increases, and becomes large as L1 decreases. Thus, the line distance of the resized image may be adjusted based on the setting of L1, the number of lines of the resized image.

Specifically, for example, L1 is set to be greater than or equal to a value obtained by dividing the width of the resized image in the vertical direction by Wpmin, a distance between two of the corresponding positions, closest to each other in the vertical direction. More specifically, if the line distance of the resized image is no more than Wpmin, the distance between two corresponding positions closest to each other in the vertical direction, in the distortion correction process for the resized image, pixel values for more than one line of the distortion-corrected image are not output for input pixel values for one line of the resized image. In other words, no more outputs are generated for less inputs. Here, if L1 is set to be a number that is not less than a value obtained by dividing the vertical width of the resized image by the distance Wpmin, the line distance of the resized image becomes no more than Wpmin. Thus, by setting L1 to be the number that is not less than the value, outputs, which are not greater than inputs, are generated for the less inputs. As a result, a handshake for pixel values of a line of the resized image is not required, and thus both the distortion correction process and the pipelining process work, as described with respect to FIG. 5 below.

FIG. 5 is a set of diagrams illustrating two positions closest to each other in the vertical direction, according to an embodiment of the present invention. Referring to FIG. 5, a resized image 30, and a range 40 in the resized image 30 corresponding to the distortion-corrected image in case of projecting the distortion-corrected image onto the resized image 30, are shown in diagram 5-1. Also, a partial area 31 of the resized image 30, in which the distance Wpmin is represented, is shown in diagram 5-2. In the partial area 31, there are corresponding positions 41a and 41b in the resized image 30 that correspond to pixels of the distortion-corrected image, and pixels 33a-33d (hereinafter, referred to as ‘virtual pixels 33a-d’) of the resized image 30 in case the resized image 30 is assumed to have as many pixels as those of the distortion-corrected image shown.

As represented in the diagram 5-2, a distance between corresponding positions 41a and 41b is Wpmin, the smallest of distances between corresponding positions in the vertical direction. The distance Wpmin is less than a distance WL, a distance between vertical pixels 33a and 33c. Assuming that a vertical width of the resized image 30 is W1, and the number of lines L1 of the resized image 30 is a value obtained by dividing the width W1 by the distance Wpmin, a line distance of the resized image and the distance Wpmin is equal. Furthermore, as the number of lines L1 of the resized image 30 is greater than the value, the line distance of the resized image becomes smaller than the distance Wpmin. Thus, the number of lines L1 of the resized image 30 should be set to be no less than the value.

In an embodiment of the present invention, the distortion-corrected image is assumed to be each frame of a full high vision image having pixels of 1,920 columns×1,080 lines. When the minimum distance Wpmin is 80% of the distance WL of the virtual pixels 33 (i.e., the distance between pixels of the distortion-corrected image), L1=WI/Wpmin=(L2×WL)/(WL×0.8)=L2/0.8=1080/0.8=1350. Thus, the number of lines of the resized image, L1, is set to be, e.g., 1350. By decreasing the number of lines L1 as much as possible, a clock frequency may be dropped, thus reducing power consumption. Furthermore, the number of columns of the resized image is set to be, e.g., 1,920, the same as the distortion-corrected image.

As such, the number of lines L1 of the resized image is set. In principle, it may be desirable for a size of an input image for the distortion correction process to be smaller, considering the drop of the clock frequency. For example, an input image having the same size as the distortion-corrected image may be considered. Despite this, in an embodiment of the present invention, by inputting an image having more lines than those of the distortion-corrected image, the distortion correction in the pipelining process is more surely enabled to work.

Furthermore, the input image, the YCbCr image, does not have fewer lines than L1. For example, if the number of lines of the YCbCr image is 2,000, then the number of lines L1 of the resized image is 1,350. By this, even in a resizing process to obtain the resized image 30 from the YCbCr image, there are not more outputs than inputs that are generated for the inputs.

Referring back to FIG. 4, the distortion correction table 111 stores information about corresponding positions in the resized image that correspond to pixels of the distortion-corrected image (hereinafter, referred to as ‘corresponding information’). The distortion-corrected image is a distortionless image, and the resized image is an image involving distortion. As described above with reference to FIG. 1, how the input YCbCr image and the resized image 30 are distorted through the optical system 101, i.e., which position in the input image and the resized image each pixel of the distortion-corrected image corresponds to, depends on characteristics of the optical system and the focal length. Thus, it is possible to store the information based on the type of the optical system or focal length in the distortion correction table 111 in advance. By storing the corresponding information, calculation and setup of L1, the number of lines of the resized image 30, becomes possible, and the distortion correction may also be possible.

The table analyzer 113 calculates the number of lines L1 based on the corresponding information. Specifically, the table analyzer 113 uses the corresponding information stored in the distortion correction table 111 to specify Wpmin, the distance between two corresponding positions 41a and 41b closest to each other in the vertical direction. The table analyzer 113 obtains a value by dividing W1, the vertical width of the resized image 30, by the distance Wpmin. The table analyzer 113 then determines L1, the number of lines of the resized image 30, to be no less than the value. L1 obtained in this manner is set to be the number of lines of the resized image 30.

The table analyzer 113 calculates L1, e.g., upon a change of the optical system 101 of the imaging apparatus 100 or the focal length. The corresponding information changes according to the characteristic and focal length of the optical system 101, and as a result, the number of lines L1 to be set up changes. Thus, when calculating L1 upon the change of the optical system 101 or the focal length, L1 may always be set to be a proper number.

The table analyzer 113 may also store L1 based on the type of the optical system 101 of the imaging apparatus 100 or the focal length. As such, storing L1 based on the type of the optical system 101 of the imaging apparatus 100, the focal length, or a combination of both, facilitates reduction of a processing load because there is no longer a need to calculate L1. The table analyzer 113 may obtain and store L1, which was calculated outside of the imaging apparatus 100, instead of calculating it.

The distortion corrector 115 sequentially obtains pixel values of each line of the distortion-corrected image having L2 lines by performing distortion correction on the resized image 300 using pixel values of one or more lines of the resized image 30 obtained by the resizer 109. For example, the distortion corrector 115 accumulates pixel values of each line of the resized image sequentially output by the resizer 109 in a line buffer. If calculation of pixel values for one line of the distortion-corrected image becomes possible by using pixel values of one or more lines accumulated in the line buffer, the distortion corrector 115 obtains pixel values for one line of the distortion-corrected image by performing the distortion correction on the accumulated pixel values. Pixel values of a distortion-corrected image, obtained as described above, are stored in, e.g., the SDRAM 117, under control of the SDRAM controller 119. The distortion-corrected image obtained as described above is, e.g., each frame of a full high vision image having pixels of 1,920 columns×1,080 lines.

Furthermore, as described above, since the resized image 30, having a suitable number of lines set up by the resizer 109, is used in the distortion correction process, the distortion correction process may surely work as a whole.

The SDRAM 117 stores an image to be temporarily preserved in the imaging apparatus 100. For example, the SDRAM 117 stores the distortion-corrected image.

The SDRAM controller 119 controls writing to the SDRAM 117 and reading from the SDRAM 117. For example, the SDRAM controller 119 controls writing of pixel values of the distortion-corrected image sequentially output by the distortion corrector 115 to the SDRAM 117. The SDRAM controller 119 also controls reading out pixel values of the distortion-corrected image to the codec 121.

The codec 121 performs compression encoding, such as MPEG (e.g., MPEG2, MPEG4, H.246, etc.) encoding, on the stored distortion-compensated image. The codec 121 outputs, e.g., an image resulting from the compression encoding to the memory card 123. When a still image rather than a moving picture is captured, the codec 121 performs the compression encoding, such as, for example, Joint Photographic Experts Group (JPEG), or Tagged Image File Format (TIFF) encoding.

The memory card 123 stores an image resulting from the compression encoding performed by the codec 121. The memory card 123 may be, for example, a Flash memory.

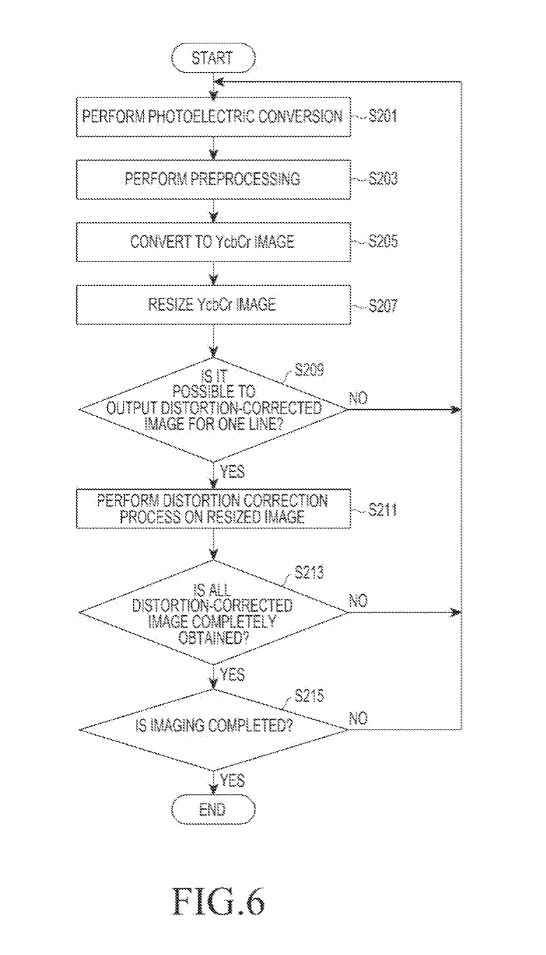

An embodiment of an imaging process is described with reference to FIG. 6. FIG. 6 is a schematic flowchart illustrating the imaging process, according to an embodiment of the present invention.

In step S201, the imaging element 103 performs photoelectric conversion. That is, the imaging element 103 converts the light beam guided from the optical system 101 into an electric signal. The imaging element 103 also performs A/D conversion on the electric signal. As a result, RAW data in the Bayer pattern is obtained. In step S203, the preprocessor 105 pre-processes (e.g., shading correction, defect correction, noise elimination, etc.) the RAW data from the imaging element 103. In step S205, the B2Y unit 107 converts the RAW data into a YCbCr image represented with luminance (Y) and chrominance (Cb, Cr).

Subsequently, in step S207, the resizer 109 obtains pixel values of each line of a resized image having L1 lines, by resizing the YCbCr image using pixel values of the YCbCr image. In step S209, the distortion corrector 115 determines whether it is possible to calculate pixel values for one line of the distortion-corrected image using pixel values of one or more lines of the accumulated resized image.

If it is not possible to calculate pixel values for one line of the distortion compensated image, the process returns to step S201. If it is possible to calculate pixel values for one line of the distortion compensated image, the distortion corrector 115 obtains pixel values for one line of the distortion-corrected image having L2 lines by performing distortion correction on the resized image 30 using pixel values of one or more lines (of the resized image 30) obtained by the resizer 109, in step S211. In step S213, the distortion corrector 115 determines whether the entire distortion-corrected image has been obtained.

If the entire distortion corrected image has not been obtained, the process returns to step S201. If the entire distortion corrected image has been obtained, it is determined whether imaging is completed, in step S215. If the imaging has not been completed, the process returns to step S201. If the imaging has been completed, the process ends.

According to an embodiment of the present invention, the imaging apparatus and method enables a reduction in power consumption by lowering a frequency at which the memory is accessed to temporarily store images. It also enables a reduction in the capacity of the memory.

The imaging apparatus of the present invention may be embodied as any device capable of capturing an image, including, for example, a digital camcorder and a digital camera.

In addition, although each image frame of a moving picture are taken as an example of an object image to be processed, a still image may also be the object image.

Furthermore, any other image formats (e.g., an RGB image), other than the foregoing YCbCr image, may be the input image.

Steps of the imaging process do not need to be processed in time series. For example, the steps of the imaging process may be processed in a different order than that described in the flowchart of FIG. 10, or processed in parallel.

While the invention has been shown and described with reference to certain embodiments thereof, it will be understood by those skilled in the art that various changes in form and detail may be made therein without departing from the spirit and scope of the invention as defined by the appended claims.

What is claimed is:

1. An imaging apparatus comprising:
a resizer for sequentially obtaining pixel values of each line of a resized image by resizing an input image using pixel values of the input image that are sequentially obtained from an imaging element, wherein the resized image has a first number of lines; and
a distortion corrector for sequentially obtaining pixel values of each line of a distortion-corrected image by performing distortion correction on the resized image using pixel values of one or more lines of the resized image, wherein the distortion-corrected image has a second number of lines;
wherein the first number of lines is set to have any two of positions in the resized image that are closest to each other in a vertical direction and that correspond to pixels of the distortion-corrected image, which have a distance that is greater than or equal to a line distance of the resized image.

2. The imaging apparatus of claim 1, wherein the first number of lines is set to be greater than or equal to a value obtained by dividing a vertical width of the resized image by a distance between the two of the positions, which are closest to each other in the vertical direction in the resized image.

3. The imaging apparatus of claim 1, further comprising a calculator for calculating the first number of lines based on information about positions in the resized image that correspond to pixels of the distortion-corrected image.

4. The imaging apparatus of claim 3, wherein the calculator calculates the first number of lines based on a change of a focal length of the imaging apparatus or a change of an optical system of the imaging apparatus.

5. The imaging apparatus of claim 1, further comprising a storage for storing the first number of lines based on a focal length of the imaging apparatus or an optical system of the imaging apparatus.

6. The imaging apparatus of claim 1, wherein the input image has a number of lines greater than or equal to the first number of lines.

7. An imaging method comprising the steps of:
sequentially obtaining pixel values of each line of a resized image by resizing an input image using pixel values of the input image that are sequentially obtained from an imaging element, wherein the resized image has a first number of lines; and
sequentially obtaining pixel values of each line of a distortion-corrected image by performing distortion correction on the resized image using pixel values of one or more lines of the resized image, wherein the distortion-corrected image has a second number of lines;
wherein the first number of lines is set to have any two of positions in the resized image that are closest to each other in a vertical direction and that correspond to pixels of the distortion-corrected image, which have a distance that is greater than or equal to a line distance of the resized image.

8. The imaging method of claim 7, wherein the first number of lines is set to be greater than or equal to a value obtained by dividing a vertical width of the resized image by a distance between the two of the positions, which are closest to each other in the vertical direction in the resized image.

9. The imaging method of claim 7, further comprising calculating the first number of lines based on information about positions in the resized image that correspond to pixels of the distortion-corrected image.

10. The imaging method of claim 9, wherein the first number of lines is calculated based on a change of a focal length of the imaging apparatus or a change of an optical system of the imaging apparatus.

11. The imaging method of claim 7, further comprising storing the first number of lines based on a focal length of the imaging apparatus or an optical system of the imaging apparatus.

12. The imaging method of claim 7, wherein the input image has a number of lines greater than or equal to the first number of lines.
